(19) United States
(12) Patent Application Publication
(10) Pub. No.: US 2017/0258061 A1
(43) Pub. Date: Sep. 14, 2017

(54) FISHING LURE WITH ADJUSTABLE ANGLE

(71) Applicant: George P. Korteweg, Mystic, CT (US)

(72) Inventor: George P. Korteweg, Mystic, CT (US)

(21) Appl. No.: 15/609,556

(22) Filed: May 31, 2017

Related U.S. Application Data
(63) Continuation-in-part of application No. 14/803,438, filed on Jul. 20, 2015.

(51) Int. Cl. A01K 85/02; A01K 85/16

(52) U.S. Cl. CPC A01K 85/02; A01K 85/16

(57) ABSTRACT

A fishing lure including a wire capable of bending and retaining a body at an angle relative to a head. The angle may be between about 0° up to about 90°. The angled head and body causes the head to move back and forth through the water as the lure is being reeled, which in turn causes the body to wag.

### CROSS-REFERENCE TO RELATED PATENT APPLICATION

This application is a continuation-in-part of U.S. non-provisional application No. 14/803,438, filed Jul. 20, 2015, the contents of which are herein incorporated by reference.

### BACKGROUND OF THE INVENTION

The present invention relates to fishing lures and, more particularly, to a fishing lure having a body and a head made of a soft material with a wire disposed within the fishing lure providing an ability to change an angle of the body relative to the head to allow changes to the swimming action.

A fishing lure is a type of artificial fishing bait which is designed to attract a fish's attention. To do this, the lure uses movement, vibration, flash and color. Many lures are equipped with one or more hooks that are used to catch fish when they strike the lure. Most lures are attached to the end of a fishing line and have various styles of hooks attached to the body and are designed to elicit a strike resulting in a hook up.

When using an artificial lure, most of the designs require the lure to be jerked or twitched by the user during the course or reeling the lure to cause the lure to appear more natural to live fish. As a result, the lure speeds up and slows down through the water, which is unnatural to a slow-moving or feeding eel or fish. Current manufactured lures of this type fail to mimic live natural movements and action.

As can be seen, there is a need for a lure that mimics live natural movements and actions of fish.

### SUMMARY OF THE INVENTION

In one aspect of the present invention, a fishing lure comprises: a head; a body attached to the head, wherein the head and body are made of a soft and flexible material; and a wire, placed internally, disposed along a longitudinal axis or parallel to the longitudinal axis of the head and the body, wherein the wire is capable of being bent and self-retaining in the body at an angle relative to the head from about 0° up to about 90°.

These and other features, aspects and advantages of the present invention will become better understood with reference to the following drawings, description and claims.

### BRIEF DESCRIPTION OF THE DRAWINGS

FIG. 1A is a perspective view of a lure with a modified “J Hook” constructed in accordance with the present invention and showing the placement of a bending wire.

FIG. 1B is a perspective view of a lure without the modified “J Hook” constructed in accordance with the present invention.

FIG. 2 is a top view of the head-scoop with the different hook eye hole variations;

FIG. 3A is a side view of the eel-type lure showing a 23 degree angle as well as the modified “J Hook” through the hook-holding knobs and where the bending wire is located;

FIG. 3B is a side view of a lure showing an 18 degree angle, the head-scoop and the modified “J Hook” rigged through the knobs and up through the head-scoop;

FIG. 4 is a side view of the convoluted-type lure showing a 28 degree angle with the hook attachment knobs on the bottom of the lure;

FIG. 5A is a side view of the eel or snake-type lure with the head-scoop attached to the molded tubing, angle body, and modified “J Hook”; and

FIG. 5B is a side view of smaller eel or snake-type lure with the head scoop attached to the molded tubing where the wire rod is placed and hook knobs without the “J Hook” attached.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fishing lure with a scooped head and an angled body and a center wire that's bendable to create a fixed angle. The lures of the present invention are designed to replicate the same movement of an eel or a fish swimming through water, thereby alleviating the user from having to jerk the lure while reeling. Once the line is attached to the fishing lure and cast out, the user may reel at any speed, creating the natural movement of an eel or fish.

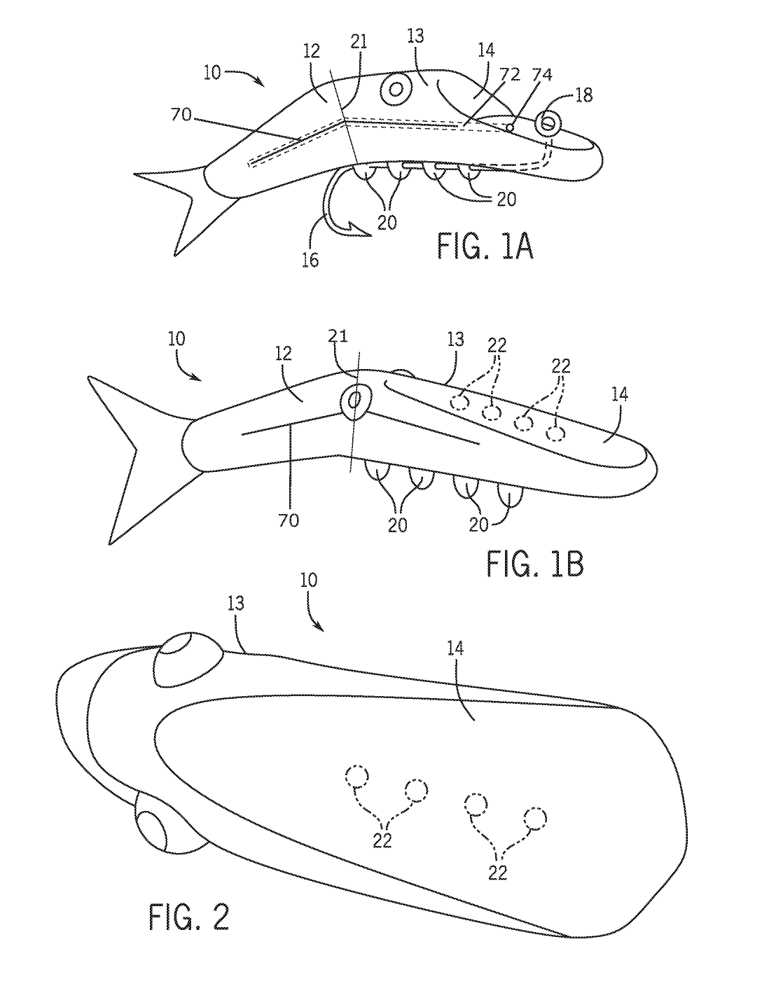

Referring to FIGS. 1 through 5, the present invention includes a fishing lure 10 including a head 13 and a body 12. The head 13 includes an upper surface and a lower surface. The body 12 is attached to the head 13. A wire 70 may be used to adjust an angle between the body 12 and the head 13. The angle may be between about 0° up to about 90°, such as 5° up to about 30°. The angled head 13 and body 12 causes the head 13 to move back and forth through the water as the lure 10 is being reeled, which in turn causes the body 12 to wag.

The wire 70 of the present invention is disposed along a longitudinal axis of the head 13 and the body 12. In certain embodiments, a channel may be formed along the longitudinal axis of the head 13 and the body 12. The channel may form an opening at the front or rear end of the lure 10. The wire 70 may be inserted and removed from the center channel. The wire 70 may thereby form a core and thereby run through the center of the head 13 and through the center of the body 12.

The wire 70 may include a bendable metal wire, such as a soft copper, brass, brass tubing, stainless steel, aluminum, and the like. In such embodiments, the head 13 and the body 12 may be bent along the wire so that a user may adjust the angle between the head 13 and the body 12. Since the head 13 and the body 12 are made of a soft material, the wire 70 self-retains the angle between the head 13 and the body 12. For example, the fishing lure 10 may start off at a 10° angle. The user may further bend the wire 70 so that the angle between the head 13 and the body 12 is at 30°. The wire 70 now self-retains the 30° angle between the head 13 and the body 12. The wire 70 may be bent from 0° up to about 90° degrees and back by removing, straightening out and reinserting.

The lure 10 of the present invention may include a fishing hook 16. The fishing hook 16 includes a hook portion and an eyelet 18 opposite the hook portion. The fishing hook 16 runs thorough the head 13 so that the eyelet 18 is disposed within the indent 14 and the hook portion is protruding from the lower surface. The J hook 16 of the present invention may include a first bend forming the hook portion and a second bend formed in the opposite direction as the hook portion. The eyelet 18 is formed beyond the second bend. The second bend is up to about 90° to a body portion of the hook 16 and about 180° relative to the hook portion of the hook 16. The second bend allows the eyelet 18 to protrude from holes preformed in the indent 14.

The present invention may include at least one knob 20 formed on a lower surface of the head 14. The hook 16 runs through the at least one knob 20 and secures the hook 16 to the lure 10. In certain embodiments, the present invention may include a plurality of knobs 20. The knobs 20 provide hook stability, and the ability to run the hook 16 outside of the lure 10.

The fishing lure 10 of the present invention may include an indent 14 or scoop formed on the upper surface of the head 13. In certain embodiments, the tip of the head 14 slopes towards the bottom surface. The indent 14 is formed in the tip. The indent 14 of the lure 10 may be designed with a set of prefabricated holes 22 which allows the user to place the hook 16 in different positions, which in turn causes different action and motion in the water. The indent 14 varies in different depths, lengths and angles, which effect the unique movement of each lure 10.

The lure 10 of the present invention may be made of a stretchable, soft material, such as a stretchable polymer. The present invention may be made as one unit using a plastic, such as thermoplastics, poured into or injected into a mold. Alternatively, the head 10 may be formed separately from the body 12 and may be secured together by an adhesive. The lure material may include a 10-1 stretch modulus and the material does not have directional tear. Therefore, old hooks 16 may be easily removed and replaced with new hooks 16 through the same knobs without tearing or breaking the lure 10.

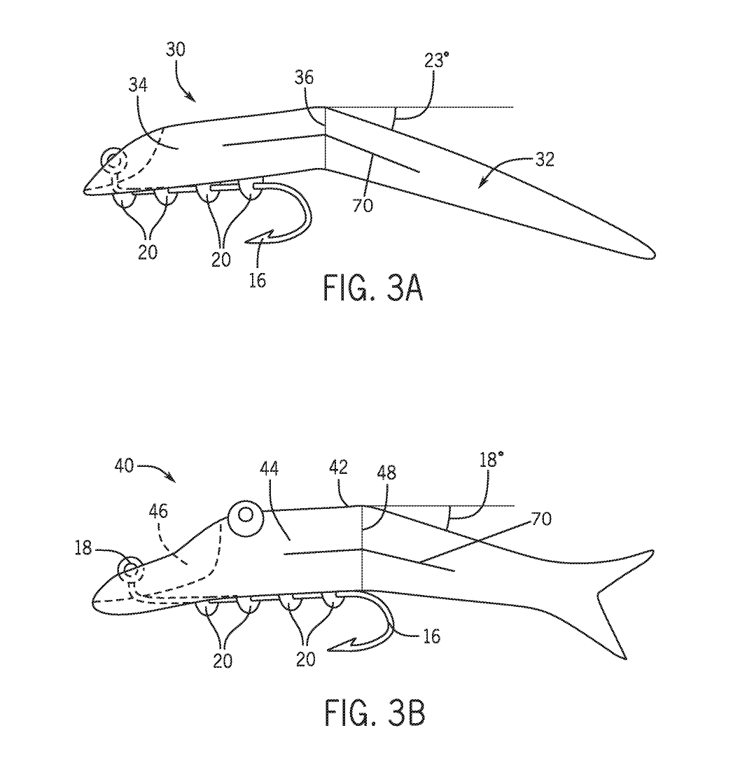

Referring to FIG. 3A, the present invention may include a lure 30 shaped like an eel. The lure 30 includes a head 34 and a body 32. The head 34 and the body 32 are joined at a bend. The bend may be at an angle 36 of 23°.

Referring to FIG. 3B, the present invention may include a lure 40 shaped like a fish. The lure 40 includes a head 44 and a body 42. The head 44 may include an indent 46 with an alternate shape and size. The head 44 and the body 42 are joined at a bend. The bend may be at an angle 48 of 18°.

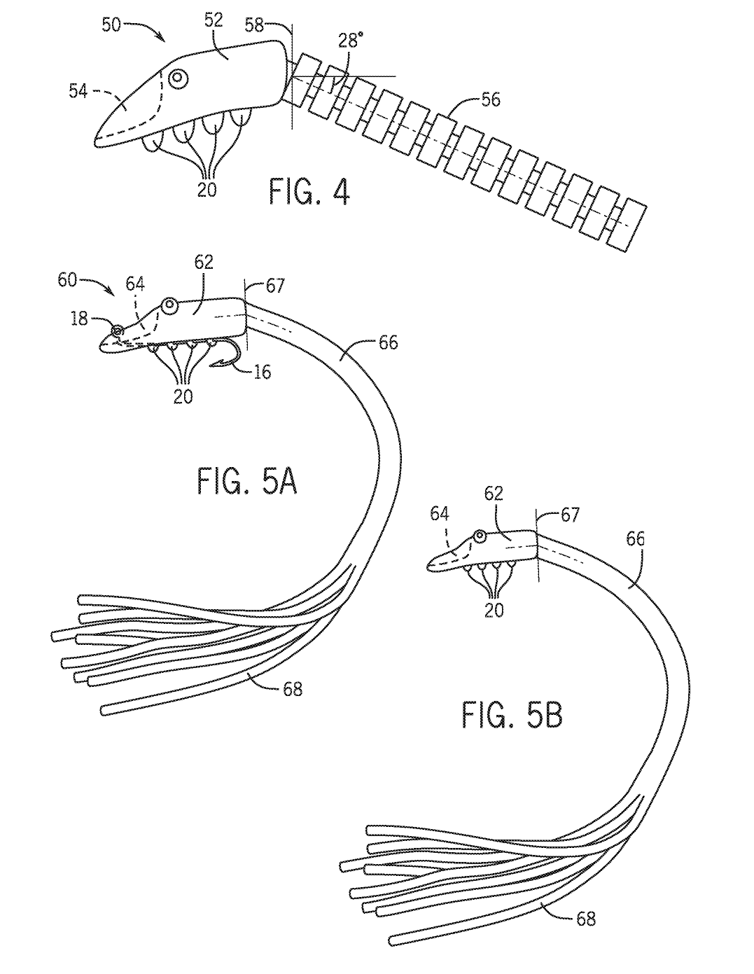

Referring to FIG. 4, the present invention may include a lure 50 shaped like an eel or worm. The lure 50 includes a head 52 and a segmented tail 56. The segmented tail 56 may allow additional side to side movement. The head 52 may include an indent 54 with an alternate shape and size. The head 52 and the tail 56 are joined at a bend. The bend may be at an angle 58 of 28°.

Referring to FIG. 5A and FIG. 5B, the present invention may include a lure 60 shaped like an eel or worm. The lure 60 includes a head 62 and a tail 66 formed of a tubing with a plurality of filaments 68 may be formed at the end. The head 62 may include an indent 64 with an alternate shape and size. The head 62 and the tail 66 are joined at a bend having an angle 67.

It should be understood, of course, that the foregoing relates to exemplary embodiments of the invention and that modifications may be made without departing from the spirit and scope of the invention as set forth in the following claims.

What is claimed is:

1. A fishing lure comprising:
a head;
a body attached to the head, wherein the head and body are made of a soft and flexible material; and
a wire disposed along a longitudinal axis or parallel to the longitudinal axis of the head and the body, wherein
the wire is capable of being bent and self-retaining the body at an angle relative to the head from about 0° up to about 90°
the wire is capable of being removed, straightened out, reinserted, then bent to a new angle.

2. The fishing lure of claim 1, wherein the wire is disposed within the head and the body in a preformed passageway.

3. The fishing lure of claim 1, wherein the wire is disposed within a central portion of the head and the body and thereby forms a core of the head and the body.

4. The fishing lure of claim 1, wherein the head comprises an upper surface and a lower surface, wherein an indent is formed in the upper surface.

5. The fishing lure of claim 4, wherein a tip of the head slopes towards the upper surface, wherein the indent is formed at the tip.

6. The fishing lure of claim 4, further comprising a fishing hook comprising a hook portion and an eyelet portion, wherein the fishing hook runs through the head so that the eyelet portion is disposed within the indent and the hook portion is protruding from the lower surface.

7. The fishing lure of claim 6, wherein the fishing hook comprises a first bend forming the hook portion, a second bend in the opposite direction as the first bend, wherein the eyelet potion is formed beyond the second bend.

8. The fishing lure of claim 7, wherein the second bend is up to about 90°.

9. The fishing lure of claim 6, further comprising at least one knob formed on a lower surface of the head, wherein the hook portion runs through the at least one knob.

10. The fishing lure of claim 9, wherein the at least one knob is a plurality of knobs.
